(19) United States
(12) Patent Application Publication
(10) Pub. No.: US 2008/0297051 A1
(43) Pub. Date: Dec. 4, 2008

(54) Electric Discharge Lamp

(75) Inventor: Cornelis Johannes Maria Denissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,755

(22) PCT Filed: Jun. 29, 2005
(86) PCT No.: PCT/IB2005/052157

§ 371 Date: Jan. 8, 2007

(30) Foreign Application Priority Data
Jul. 6, 2004 (EP) 04103185.7

(51) Int. Cl. H01J 61/36; H01J 9/26

(52) U.S. Cl. 313/625; 445/27

(57) ABSTRACT

An electric discharge lamp comprising: a light-transmissive ceramic lamp vessel; a first and a second current conductor entering the lamp vessel and each supporting an electrode in the lamp vessel; a sealing compound sealing the lamp vessel around the current conductors in a gastight manner, said sealing compound at least substantially comprising a noble metal; an ionizable filling comprising a rare gas and metal halide in the lamp vessel; at least the first current conductor comprising niobium, characterized in that said first current conductor is coated with a material 10 selected from the group consisting of NbN, NbB₂, NbSi₂, and NbC.

The present invention relates to an electric discharge lamp comprising:
a light-transmissive ceramic lamp vessel;
a first and a second current conductor entering the lamp vessel and each supporting an electrode inside the lamp vessel;
a sealing compound in a sealing location, sealing the lamp vessel around the current conductors in a gastight manner, said sealing compound at least substantially comprising a noble metal;
an ionizable filling comprising a rare gas and metal halide inside the lamp vessel;
   at least the first current conductor comprising niobium.

Such an electric lamp is known from EP-A-0 587 238. This known lamp is equipped with an ionizable filling comprising mercury. The current conductor of such a lamp must have a linear coefficient of thermal expansion which corresponds to that of the lamp vessel in order to prevent leakage of the lamp. Leakage may even occur in the manufacture of the lamp when the lamp cools down after the sealing compound has been provided at a relatively high temperature. At a too small coefficient of expansion of the current conductor, the lamp vessel shrinks to a stronger extent and it may crack or even break. At a too great coefficient of expansion, leakage may occur around the current conductors. However, the current conductors must also be resistant to the ionizable filling of the lamp, particularly to halides, at least in so far as they are in contact therewith: they should at least not substantially be attacked by or react with halides or halogens formed therefrom. A low resistance may not only result in damage and destruction of the current conductor but also in a loss of halide in the filling and in a color change of the light generated by the lamp. Moreover, the current conductors must withstand the thermal manufacturing and operating conditions of the lamp and, to counteract electrical losses, they should be good conductors. Since the requirements imposed on expansion and chemical resistance are often not combined in one material, at least the first current conductor of the known lamp has an inner halide-resistant part within the lamp vessel having a different expansion from that of the lamp vessel, and an outer part which extends from the seal and is not halide-resistant, but which does have a corresponding expansion. This outer part often consists of niobium, tantalum, or an alloy thereof, metals which, due to their oxidation sensitivity at higher temperatures, should be screened from the air by means of an outer envelope of the lamp. If the lamp vessel is relatively narrow and elongate, and if it has a vertical operating position, the halogen formed from the halide is particularly present in the upper portion of the lamp vessel. It is then sufficient when only the first current conductor has an inner halide-resistant portion and is present in the upper part of the lamp vessel. However, the lamp cannot be operated upside down, horizontally, or obliquely in that case. The lamp may be given a second current conductor corresponding to the first for obtaining a universal operating position. The inner part of each current conductor of the known lamp generally comprises a molybdenum coil or a cermet of molybdenum and aluminum oxide.

It is a drawback of the known lamp that the sealing compound sealing the ceramic lamp vessel around the current conductors is sensitive to high (operating) temperatures occurring in the lamp. Therefore, it is necessary in the known lamp to apply the sealing compound as remote as possible from a central part of the lamp vessel, i.e. at a free end of extended plugs (i.e. elongated parts) that are connected, i.e. sintered to the central part of the lamp vessel. Consequently, the construction of the known lamp is not as compact as desirable. Furthermore, the use of said extended plugs is undesirable from a technical point of view: said plugs function as cooling fins negatively influencing an operating temperature in the lamp vessel, while capillaries are introduced in said extended plugs. Part of the lamp filling, particularly molten salts, may condense in a so-called dead volume in said extended plugs at the location of the capillaries, leading to color instability of the lamp. In the known lamp, an excess of such (expensive) salts needs to be dosed to compensate for the loss of part of the salts in said dead volume.

It is an object of the present invention to obviate these disadvantages. To achieve this object, according to the invention, an electric lamp of the type referred to in the introduction is characterized in that said first current conductor is coated in the sealing location with a material selected from the group consisting of NbN, NbB₂, NbSi₂, and NbC. Particularly, said first current conductor has a core of niobium, which core is entirely coated with a material as mentioned above. Said material particularly has a thickness varying between 10 and 200 mm, preferably 100 mm.

In one embodiment of an electric discharge lamp in accordance with the invention, said sealing compound comprises at least substantially PtNb. Preferably, said sealing compound comprises between 45 and 100% Pt, preferably between 50 and 60% Pt. The use of Pt ensures that the sealing compound is resistant to halogens, while the sealing compound protects the materials of the first current conductor from being attacked by said halogens.

The present invention also relates to a method of manufacturing an electric discharge lamp comprising:
a light-transmissive ceramic lamp vessel;
a first and a second current conductor entering the lamp vessel and each supporting an electrode inside the lamp vessel;
a sealing compound sealing the lamp vessel around the current conductors in a gastight manner, said sealing compound at least substantially comprising a noble metal;
an ionizable filling comprising a rare gas and metal halide inside the lamp vessel;
at least the first current conductor comprising niobium, characterized in that said first current conductor is provided with a coating of a material selected from the group consisting of NbN, NbB₂, NbSi₂, and NbC.

In one embodiment of a method of manufacturing an electric discharge lamp in accordance with the invention, the coating is applied through deposition, particularly vapor deposition, more in particular chemical vapor deposition or physical vapor deposition. The deposition comprises nitride, for example.

The invention will now be explained in more detail with reference to two Figures illustrated in a drawing, wherein

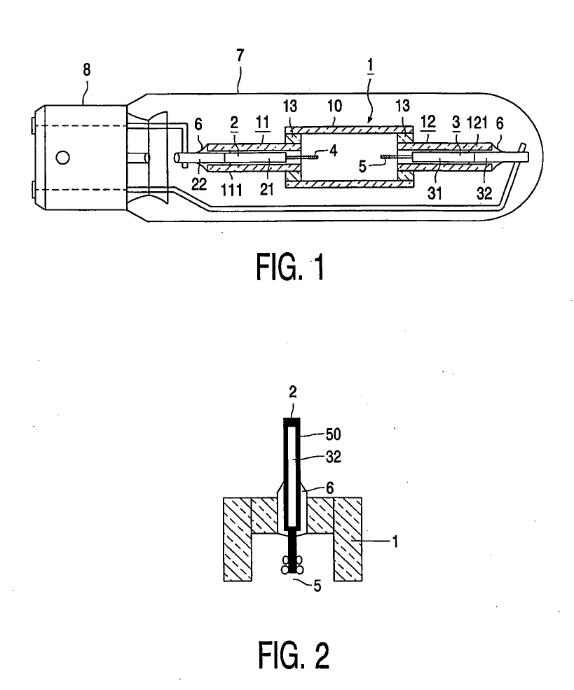

FIG. 1 shows a prior art electric discharge lamp in a side elevation, partly in cross-section; and

FIG. 2 schematically shows an embodiment of one end of an electric discharge lamp in accordance with the invention in cross-section.

FIG. 1 shows an electric discharge lamp in accordance with the prior art provided with a tubular, light-transmissive, ceramic lamp vessel 1 made from polycrystalline aluminum oxide, with a first and a second current conductor 2,3. Said conductors 2,3 enter the lamp vessel 1 opposite each other and support respective tungsten electrodes 4,5 present inside the lamp vessel 1 and welded to the current conductors 2,3. A ceramic sealing compound 6 formed in a melting process from 30% by weight of aluminum oxide, 40% by weight of silicon oxide, and 30% by weight of dysprosium oxide seals the current conductors 2,3 in a gastight manner. The lamp vessel 1 has an ionizable filling comprising argon as a rare gas and a mixture of sodium, thallium and dysprosium iodide as metal halides. The first and the second current conductor 2,3 each have a first halide-resistant part 21,31 within the lamp vessel 1 and, extending from the ceramic sealing compound 6 to the exterior of the lamp vessel 1, a second part 22,32 welded to the first part 21,31. The second part 22,32 of each current conductor 2,3 consists of niobium and is entirely incorporated in the ceramic sealing compound 6 within the lamp vessel 1. In an alternative embodiment, both current conductors 2,3 are each made in one piece of one material.

The lamp vessel 1 has narrow end parts or extended plugs 11,12 in which respective current conductors 2,3 are enclosed. The plugs 11,12 each have a free end 111,121, where the lamp vessel 1 is sealed by the ceramic sealing compound 6. The central part 10 of the lamp vessel 1 is connected by sintering to the plugs 11,12 via ceramic discs 13. The lamp vessel 1 is enveloped by an outer envelope 7 that is sealed in a gastight manner and is evacuated or filled with an inert gas in order to protect the niobium second parts 22,32 of the current conductors 2,3. The outer envelope 7 supports a lamp cap 8.

FIG. 2 schematically shows one end of a tubular, light-transmissive, ceramic lamp vessel 1 in accordance with a preferred embodiment of the invention, wherein a very compact lamp construction is realized. The tungsten electrode 5 present inside the lamp vessel 1 is joined (preferably welded) to the first current conductor 2. Said first current conductor 2 extends from the sealing compound 6 to the exterior of the lamp vessel 1. Said first current conductor 2 comprises a core 32 of niobium that is coated with a material 50 selected from the group consisting of NbN, NbB₂, NbSi₂, and NbC. Extensive research has revealed that NbN and NbB₂ are the most effective coatings in the sense that niobium of the core 32 is prevented from reacting with components of the sealing compound in the sealing location. In the embodiment described, the sealing compound preferably comprises PtNb-material. The described coating thus prevents the Nb of the current conductor from reacting with the Pt within the PtNb-material of the sealing compound 6. Larger amounts of Pt can thus be used in the sealing compound 6, even up to 100%. Said sealing compound 6 encloses said first current conductor 2 such that halogens present in the lamp vessel 1 cannot react with the materials used in the first current conductor 2, as can be seen from FIG. 2. The use of Pt ensures that the sealing compound 6 is resistant to halogens.

Suitable methods of applying the coating on the current conductor 2 are deposition, in particular vapor deposition, for instance chemical vapor deposition or physical vapor deposition.

The invention is not restricted to the embodiments shown in the drawing, but it also extends to other embodiments that fall within the scope of the appended claims.

1. An electric discharge lamp comprising:
a light-transmissive ceramic lamp vessel;
a first and a second current conductor entering the lamp vessel and each supporting an electrode inside the lamp vessel;
a sealing compound in a sealing location, sealing the lamp vessel around the current conductors in a gastight manner, said sealing compound at least substantially comprising a noble metal;
an ionizable filling comprising a rare gas and metal halide inside the lamp vessel;
at least the first current conductor comprising niobium,
characterized in that said first current conductor is coated at the sealing location with a material selected from the group consisting of NbN, NbB₂, NbSi₂, and NbC.

2. An electric discharge lamp according to claim 1, wherein said material has a thickness varying between 10 and 200 mm, preferably 100 mm.

3. An electric discharge lamp according to claim 1, wherein said sealing compound comprises at least substantially PtNb.

4. An electric discharge lamp according to claim 3, wherein said sealing compound comprises between 45 and 100% Pt, preferably between 50 and 60% Pt.

5. Method of manufacturing an electric discharge lamp comprising:
a light-transmissive ceramic lamp vessel;
a first and a second current conductor entering the lamp vessel and each supporting an electrode inside the lamp vessel;
a sealing compound sealing the lamp vessel around the current conductors in a gastight manner, said sealing compound at least substantially comprising a noble metal;
an ionizable filling comprising a rare gas and metal halide inside the lamp vessel;
at least the first current conductor comprising niobium,
characterized in that said first current conductor is provided with a coating of a material selected from the group consisting of NbN, NbB₂, NbSi₂, and NbC.

6. Method according to claim 5, wherein the coating is provided by deposition, particularly vapor deposition, more in particular chemical vapor deposition or physical vapor deposition.
